(19) United States
(12) Patent Application Publication
(10) Pub. No.: US 2025/0274383 A1
(43) Pub. Date: Aug. 28, 2025

(54) NETWORK DISCONNECTION RECOVERY IN AN ACCESS DEVICE

(71) Applicant: Charter Communications Operating, LLC, St. Louis, MO (US)

(72) Inventors: Deependra Singh Rawat, Highlands Ranch, CO (US); Shlomo Ovadia, Denver, CO (US)

(21) Appl. No.: 18/588,221

(22) Filed: Feb. 27, 2024

(51) Int. Cl. H04L 45/28; H04L 67/51

(52) U.S. Cl. CPC H04L 45/28; H04L 67/51

(57) ABSTRACT

An access device communicatively coupled to a local area network (LAN) and to an aggregation device in a service provider network establishes layer 3 connectivity with the service provider network via a main network service. Subsequent to establishing layer 3 connectivity to the service provider network, the access device determines that the main network service has lost layer 3 connectivity to the service provider network. The access device attempts to re-establish layer 3 connectivity with the service provider network using a backup network service.

### BACKGROUND

If an access device, such as cable modem or optical network unit, loses layer 3 connectivity, a local area network (LAN) associated with the access device also loses layer 3 connectivity and computing devices on the LAN can no longer communicate with computing devices external to the LAN.

### SUMMARY

The examples disclosed herein implement network disconnection recovery in an access device.

In one implementation a method is provided. The method includes establishing, by an access device communicatively coupled to a local area network (LAN) and to an aggregation device in a service provider network, layer 3 connectivity with the service provider network via a main network service. The method further includes subsequent to establishing layer 3 connectivity to the service provider network, determining, by the access device, that the main network service has lost layer 3 connectivity to the service provider network. The method further includes attempting, by the access device, to re-establish layer 3 connectivity with the service provider network using a backup network service.

In another implementation an access device is provided. The access device includes a memory, and one or more processor devices operable to establish layer 3 connectivity with a service provider network via a main network service. The one or more processor devices are further operable to, subsequent to establishing layer 3 connectivity to the service provider network, determine that the main network service has lost layer 3 connectivity to the service provider network. The one or more processor devices are further operable to attempt to re-establish layer 3 connectivity with the service provider network using a backup network service.

In another implementation a non-transitory computer-readable storage medium is provided. The non-transitory computer-readable storage medium includes executable instructions operable to cause one or more processor devices of an access device to establish layer 3 connectivity with a service provider network via a main network service. The instructions are further operable to cause the one or more processor devices to, subsequent to establishing layer 3 connectivity to the service provider network, determine that the main network service has lost layer 3 connectivity to the service provider network. The instructions are further operable to attempt to re-establish layer 3 connectivity with the service provider network using a backup network service.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIGS. 1A-1C are block diagrams of an environment at different points in time in which network disconnection recovery in an access device can be practiced according to some implementations;

FIG. 2 is a flowchart of a method for network disconnection recovery in an access device according to one implementation;

FIG. 3 is a flowchart of a method for network disconnection recovery in an access device according to another implementation; and

FIG. 4 is a block diagram of an access device suitable for implementing examples according to one implementation.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

A customer typically connects to an Internet service provider network via a hardware device in the customer premises. The hardware device is often called a customer premises equipment (CPE) or access device. The access device may be, for example, a cable modem or an optical network unit (ONU) or optical network terminal (ONT). The access device may be coupled to a router via a local area network (LAN) port and to an edge device in the service provider's network, such as a cable modem termination system (CMTS) or optical line terminal (OLT) via a wide-area network (WAN) port. Some access devices include router functionality and may be coupled to an access point that communicates with client computing devices.

A service provider may obtain information from an access device and/or provision or otherwise control the access device using multiple different systems, depending on the particular action that needs to be performed on the access device. In some situations an access device may even require an individual to be able to physically manipulate the access device to cause certain things to happen. In such situations a service provider technician must travel to the access device to perform the desired operation on the access device. This is a relatively expensive and time-consuming process for the service provider, and may result in extended downtime for the customer until the technician arrives and resolves a problem.

Cloud-based command and control (CaC) technology, such as OpenSync® by way of non-limiting example, available at opensync.io, has been developed that provides cloud-controlled and cloud-managed software to identify and manage connected devices with data security. CaC features may include, by way of non-limiting example, unified device configuration management, device firmware upgrade capabilities, and the like, and eliminates the need to utilize multiple separate systems to control or otherwise configure the access device. Typically, a CaC agent is installed on the access device and the CaC agent communicates with a CaC controller implemented on a remote computing device in the service provider's network, which may sometimes be referred to as cloud CaC software.

Such CaC software can greatly reduce maintenance and training costs for the service provider, and greatly reduce downtime for a customer. On the access device the CaC agent may be implemented as part of the network services of the access device and is responsible for configuring network interfaces and other network-related operations. Because the CaC agent is part of the network services of the access device, a problem with the CaC agent may impact the ability of the access device to communicate with the service provider network, which will likewise prevent any computing device on the LAN to which the access device is coupled from reaching the Internet. One such problem may arise when the CaC agent and the CaC controller somehow lose the ability to communicate with one another. This may occur, for example, due to unknown bugs in either the CaC agent or the CaC controller, a fault in the CaC agent or the CaC controller, or the like.

When this happens, the LAN loses Internet access resulting in immediate customer dissatisfaction. Because the issue may be the CaC controller rather than the CaC agent, rebooting the access device or otherwise attempting to diagnose the access device will not resolve the problem. The problem cannot be resolved until the CaC controller, or the connection to the CaC controller, is fixed.

The examples disclosed herein implement network disconnection recovery in an access device. An access device has two network services, a main network service that implements a cloud CaC software via a CaC agent and a backup network service that lacks the CaC agent and need not communicate with a CaC controller in the cloud, but which does not provide CaC to the access device. During an initialization phase of the access device, the access device establishes layer 3 connectivity with the service provider network via the main network service. The access device continuously monitors the main network service to determine whether layer 3 connectivity has been lost. If so, the access device alters a configuration option to cause the access device to establish layer 3 connectivity using the backup network service during the initialization phase. The access device then causes the access device to re-enter the initialization phase. The access device accesses the configuration option during the initialization phase and determines that the backup network service is to be used rather than the main network service, and establishes layer 3 connectivity using the backup network service. In this manner, when available, the access device may implement CaC functionality that enables the service provider to perform operations on and obtain information from the access device remotely. If the CaC software suffers a problem, the access device can relatively quickly resort to the backup network service to ensure the access device and the LAN to which the access device is coupled has layer 3 connectivity, even in the absence of CaC functionality.

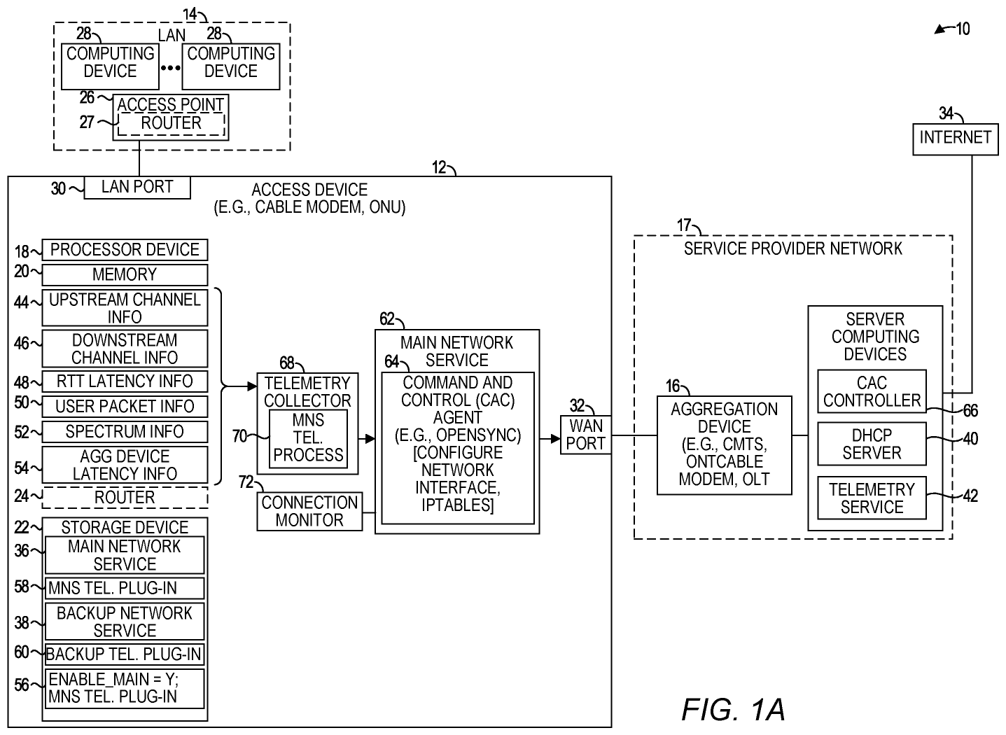

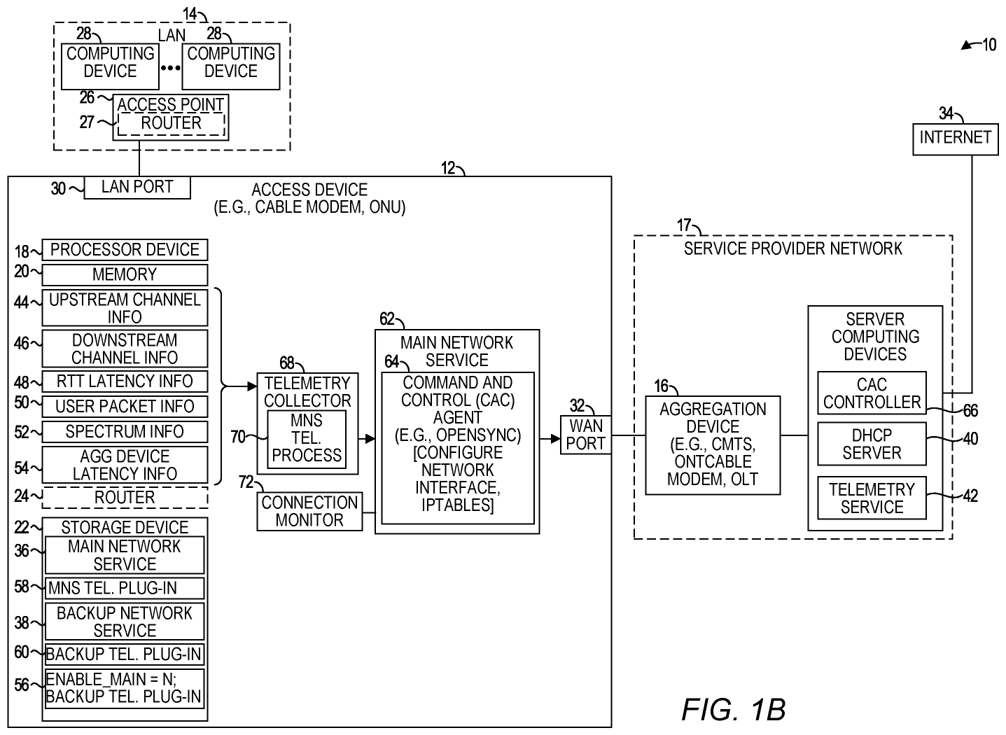

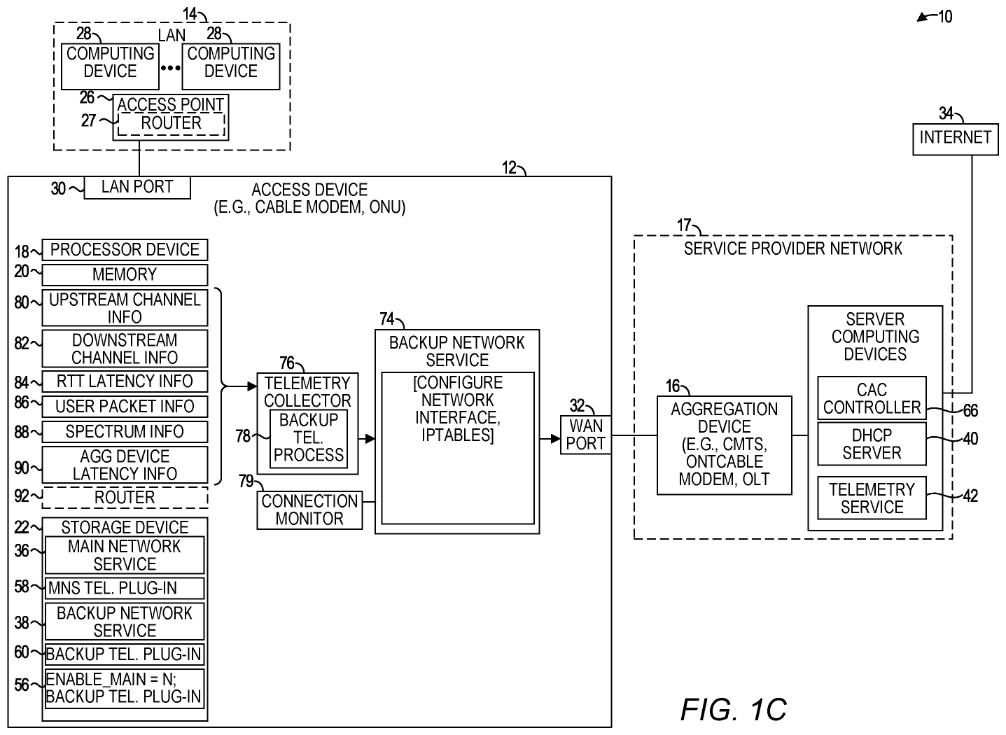

FIG. 1A is a block diagram on an environment 10 in which network disconnection recovery in an access device can be practiced according to some implementations. The environment 10 includes an access device 12 that is communicatively coupled to a local area network (LAN) 14 and to an aggregation device 16 in a service provider network 17. There may be one or more networks between the access device 12 and the aggregation device 16, such as, by way of non-limiting example, a hybrid-fiber coaxial network, or a distributed access architecture network. The access device 12 includes one or more processor devices 18 (hereinafter referred to as “the processor device 18” for the sake of brevity), one or more memories 20 (hereinafter referred to as “the memory 20” for the sake of brevity), and one or more storage devices 22 (hereinafter referred to as “the storage device 22” for the sake of brevity).

The access device 12 may comprise, by way of non-limiting example, a cable modem or an optical network unit. In some implementations, the access device 12 may include a router 24 and may connect to the LAN 14 via a connection to an access point 26. The access point 26 may be a wired and/or wireless access point, and may enable connections with a plurality of computing devices 28 via either Wi-Fi, a wired Ethernet cable, or both. In some implementations, the access point 26 may include a router 27. In some implementations, the access point 26 may comprise an OpenSync connected Wi-Fi router. The access device 12 may connect to the access point 26 via a LAN port 30. The LAN port 30 may comprise an Ethernet port. The aggregation device 16 may comprise, by way of non-limiting example, a cable modem termination system (CMTS) or an optical line terminal. Where the aggregation device 16 is a CMTS, the access point 26 may connect to the aggregation device 16 via a WAN port 32, which may comprise, by way of non-limiting example, a coaxial cable port. Where the aggregation device 16 is an optical line terminal, the wide-area network port 32 may comprise, by way of non-limiting example, an optical fiber port. The access device 12, among other functionality, provides layer 3 connectivity between the computing devices 28 and computing devices on other networks, such as the Internet 34. The access device 12 and the aggregation device 16 may communicate via a layer 2 communications protocol.

Upon power-up, or a reboot, the access device 12 enters an initialization phase that involves loading and initiating an operating system (OS) and otherwise setting up the access device 12 for communications with other devices, such as the access point 26 and the aggregation device 16. During this initialization phase, the access device 12 initiates either a main network service 36 or a backup network service 38 to establish layer 3 connectivity with the service provider network 17. In particular, the access device 12 may obtain an IP address from a DHCP server 40 in the service provider network 17 to establish layer 3 connectivity.

During normal operations, the access device 12 may continuously collect, maintain and send telemetry data to a telemetry service 42 in the service provider network 17, where such telemetry data may be processed, analyzed, and/or aggregated over time, and presented on a display device for an operator. Each of the telemetry metrics described below may have the same or different collection periods. In some implementations, a default collection time may be, by way of non-limiting example, 30 seconds. Such telemetry data may, by way of non-limiting example, include upstream channel information 44 that includes DOCSIS upstream channel information (e.g., RF level, channel frequency) used by the access device 12 to send data to the aggregation device 16; downstream channel information 46 (e.g., RF level, channel frequency) used by the access device 12 to receive data from the aggregation device 16; round-trip (RTT) latency information 48 that identifies round trip latencies between the access device 12 and the computing devices 28; packet information 50 that identifies the number of transmitted and received packets from each of the computing devices 28; spectrum information 52 that identifies the RF downstream and upstream spectrum of the access device 12; aggregation device minimum, maximum, and average roundtrip information 54 that identifies the DOCSIS latency between the access device 12 and the aggregation device 16; downstream and upstream speed test results; security information of the access device 12, and the like. Each of the telemetry components 44-54 may comprise processes, such as plug-in modules, that are operable to monitor or otherwise determine the particular telemetry data for which the telemetry component 44-54 is responsible for collecting. The formatting or packaging of the telemetry data on the access device 12 and the streaming of such data to the telemetry service 42 may differ depending on whether the main network service 36 or the backup network service 38 is used to establish layer 3 connectivity to the service provider network 17.

During the initialization phase the access device 12 may access a configuration option 56 to determine whether to utilize the main network service 36 or the backup network service 38 to establish layer 3 connectivity. The configuration option 56 may be maintained, for example, on the storage device 22 or stored in a non-volatile memory of the access device 12. In this example, the configuration option 56 indicates that the access device 12 should utilize the main network service 36 to establish layer 3 connectivity (e.g., “ENABLE_MAIN=Y”). The configuration option 56 also indicates that a main network service (MNS) telemetry plug-in 58 should be used to collect and stream the telemetry data to the telemetry service 42 (e.g., “MNS TEL. PLUG-IN”). If the backup network service 38 were utilized to establish layer 3 connectivity, a backup telemetry plug-in 60 would be used to collect and stream the telemetry data to the telemetry service 42 in lieu of the main network service telemetry plug-in 58.

During the device boot up process (i.e., the initialization phase) the access device 12 initiates the main network service 36 to instantiate an executing main network service 62. The main network service 62 includes a CaC agent 64 that is operable to establish communications with a CaC controller 66 that is executing in the service provider network 17. The CaC agent 64 receives configuration information from the CaC controller 66 that allows the CaC agent 64 to configure network interfaces (e.g., bringing interfaces up, creating software bridges), initiate a firewall (e.g., establishing IPtable rules), establish routing rules (e.g., how packets flow between the LAN port 30 and the WAN port 32), and establish layer 3 connectivity with the service provider network 17, such as by obtaining an IP address from the DHCP server 40. If connectivity with the CaC controller 66 is subsequently lost, the configuration information is lost and thus layer 3 connectivity is lost. The CaC agent 64 may attempt to re-establish connectivity to the CaC controller 66, however, if not successful, layer 3 communications between the access device 12 and the service provider network 17 cannot be established.

The access device 12 initiates a telemetry collector 68 which in turn instantiates the main network service telemetry plug-in 58 as an executing main network service telemetry process 70. The access device 12 also initiates a connection monitor 72 that is operable to monitor connectivity and determine if the main network service 62 has lost layer 3 connectivity. The particular monitoring mechanism may differ depending on the particular CaC implementation. In the case of an OpenSync CaC implementation, the connection monitor 72 may issue an OpenvSwitch command, such as an “ovs-vsctl show” command to access the CaC configuration file which contains information indicating whether the CaC connection is established. Other CaC implementations may be monitored based on how such CaC implementations maintain CaC connectivity status.

While the main network service 62 has layer 3 connectivity, the access device 12 is operable to receive data transmitted by a computing device 28 and forward such data to a destination on another network, such as the Internet 34, and receive data from another network, such as the Internet 34, and send such data to a computing device 28. The telemetry collector 68 periodically, such as every five seconds, 10 seconds, 30 seconds, or any other suitable or desirable period of time, collects and streams the telemetry data to the telemetry service 42.

Referring now to FIG. 1B, for purposes of illustrating network disconnection recovery in the access device 12 according to one implementation, assume that the connection monitor 72 determines that the main network service 62 has lost layer 3 connectivity to the service provider network 17. This may occur, for example, because the CaC controller 66 has faulted or for some other reason the CaC agent 64 and the CaC controller 66 can no longer communicate with one another. Having lost layer 3 connectivity to the service provider network 17, the computing devices 28 can no longer communicate with networks that are external to the LAN 14, such as the service provider network 17 or the Internet 34, and the telemetry collector 68 can no longer stream the telemetry data to the telemetry service 42.

In response to determining that the main network service 62 has lost layer 3 connectivity to the service provider network 17, the access device 12 alters the configuration option 56 to cause the access device 12 to establish layer 3 connectivity with the service provider network 17 using the backup network service 38 (e.g., “ENABLE_MAIN=N”) that lacks the CaC functionality during the initialization phase. The access device 12 also alters the configuration option 56 to indicate that the backup telemetry plug-in 60 should be used to collect and stream the telemetry data to the telemetry service 42 (e.g., “BACKUP TEL. PLUG-IN”). The access device 12 than causes the access device 12 to re-enter the initialization phase, such as, by way of non-limiting example, by causing the access device 12 to reboot.

Referring now to FIG. 1C, the access device 12 re-enters the initialization phase. The access device 12 determines, based on the configuration option 56, to establish layer 3 connectivity with the service provider network 17 using the backup network service 38 rather than the main network service 36. The access device 12 initiates the backup network service 38 to instantiate an executing backup network service 74. The backup network service 74 lacks the CaC agent. The backup network service 74 configures network interfaces, IPtables, and establishes layer 3 connectivity with the service provider network 17, such as by obtaining an IP address from the DHCP server 40.

The access device 12 also initiates appropriate plug-ins 80-90 to stream, via a backup telemetry process 78, the telemetry data described above with regard to FIG. 1A. If the access device 12 also provides router functionality for the LAN 14, the access device initiates a router 92. In this manner, the access device 12 automatically recovers from the network disconnection associated with the CaC agent 64 and the CaC controller 66, without human involvement and with minimal disruption to the LAN 14.

The access device 12 also initiates a connection monitor 79 that is operable to monitor connectivity to the CaC cloud system to determine whether the CaC controller 66 (or a subsequently initiated CaC controller in the event the CaC controller 66 terminated), becomes reachable. The particular monitoring mechanism may differ depending on the particular backup network service implementation. In one implementation, the connection monitor 79 may cause a message that requests a reply (e.g., a ping command) to be sent to an IP address associated with the CAC controller 66. The connection monitor 79 may set a timer. The timer duration value may be randomly selected or may be a fixed value. If the timer expires and a reply has not been received, the connection monitor 79 may determine that the main network service remains unavailable. If a reply is received prior to the timer expiring, the connection monitor 79 determines that cloud connectivity has been re-established and that the main network service may now be available. The access device 12 may then alter the configuration option 56 to cause the access device 12 to establish layer 3 connectivity with the service provider network 17 using the main network service 36 (e.g., “ENABLE_MAIN=Y”). The access device 12 also alters the configuration option 56 to indicate that the MNS telemetry plug-in 58 should be used to collect and stream the telemetry data. The access device 12 than causes the access device 12 to re-enter the initialization phase, such as, by way of non-limiting example, by causing the access device 12 to reboot.

It is noted that various components, such as the telemetry collector 68, the connection monitor 72, the telemetry components 44-54, and the router 24 are illustrated separately for purposes of illustration. However, because such components are components of the access device 12, functionality implemented by such components may be attributed to the access device 12 generally. Moreover, in examples where the components comprise software instructions that program the processor device 18 to carry out functionality discussed herein, functionality implemented by the components may be attributed herein to the processor device 18.

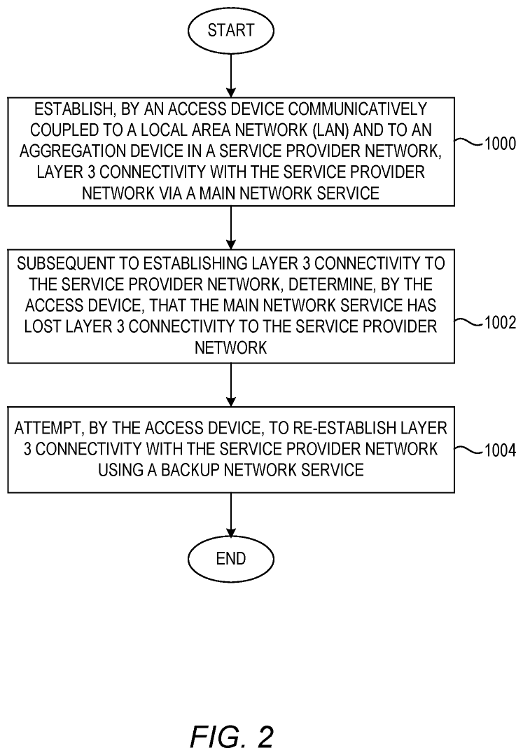

FIG. 2 is a flowchart of a method for network disconnection recovery in an access device according to one implementation. FIG. 2 will be discussed in conjunction with FIGS. 1A-1C.

The access device 12, communicatively coupled to the LAN 14 and to the aggregation device 16 in the service provider network 17, establishes layer 3 connectivity with the service provider network 17 via the main network service 36 (FIG. 2, block 1000). Subsequent to establishing layer 3 connectivity to the service provider network 17, the access device 12 determines that the main network service 36 has lost layer 3 connectivity to the service provider network 17 (FIG. 2, block 1002). The access device 12 attempts to re-establish layer 3 connectivity with the service provider network 17 using the backup network service 38 (FIG. 2, block 1004).

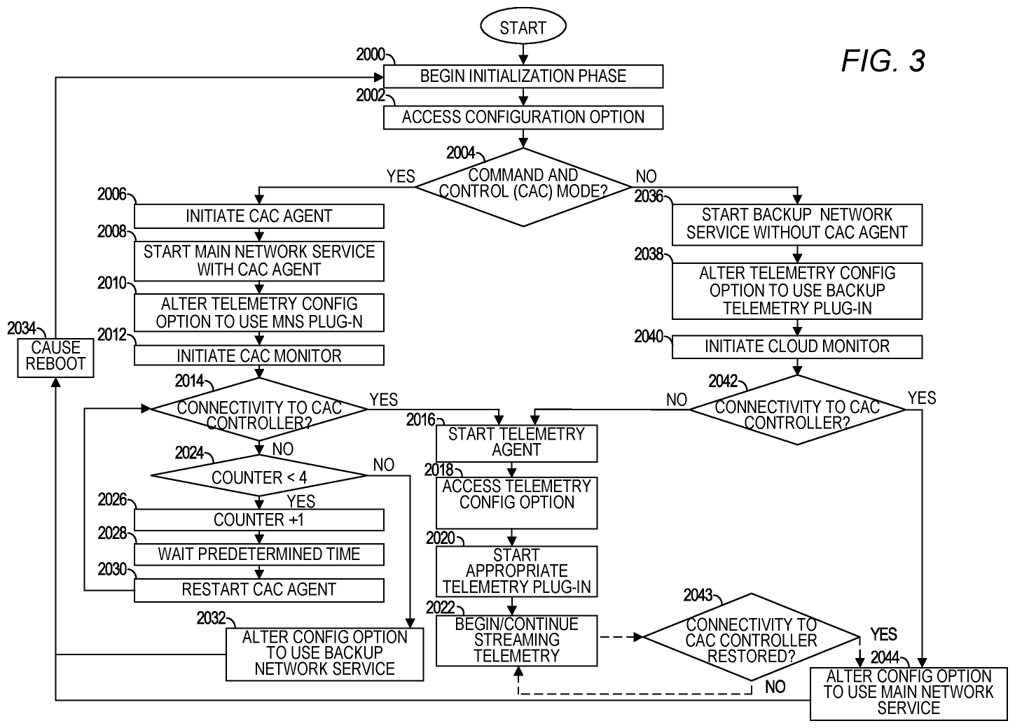

FIG. 3 is a flowchart of a method for network disconnection recovery in an access device according to another implementation. FIG. 3 will be discussed in conjunction with FIGS. 1A-1C. The access device 12 begins the initialization phase (FIG. 3, block 2000). This may occur, for example, when the access device 12 has been powered on, or causes itself to reboot, or faults and automatically reboots. The initialization phase is prior to a phase when the access device 12 is prepared to communicate data between the LAN 14 and the service provider network 17. At the beginning of the initialization phase the access device 12 does not have layer 3 connectivity with the service provider network 17. The access device 12 accesses the configuration option 56 (FIG. 3, block 2002). The access device 12 determines, based on the configuration option 56, that the access device 12 is to enter a CaC mode (e.g., “ENABLE_MAIN=Y”) (FIG. 3, block 2004).

The access device 12 initiates the CaC agent 64 (FIG. 3, block 2006). The access device 12 starts the main network service 62 to use the CaC agent 64 (FIG. 3, block 2008). In this implementation, the access device 12 alters a telemetry configuration option so that the telemetry collector 68 will use the MNS telemetry plug-in 58 (FIG. 3, block 2010). The access device 12 initiates the connection monitor 72 (FIG. 3, block 2012). The access device 12 determines whether the CaC agent 64 has connectivity to the CaC controller 66 (FIG. 3, block 2014). If so, the access device 12 initiates the telemetry collector 68 (FIG. 3, block 2016). The telemetry collector 68 accesses the telemetry configuration option in the configuration option 56 and determines that the main network service telemetry plug-in 58 is to be used to collect and stream the telemetry data rather than the backup telemetry plug-in 60 (FIG. 3, block 2018). The telemetry collector 68 instantiates the main network service telemetry plug-in 58 as an executing main network service telemetry process 70 (FIG. 3, block 2020). The access device 12 initiates the telemetry components 44-54. The telemetry collector 68 begins streaming the telemetry data via the CaC agent 64 to the telemetry service 42 (FIG. 3, block 2022).

If at block 2014 the access device 12 determined that there was no connectivity between the CaC agent 64 and the CaC controller 66, and thus that layer 3 connectivity is not established, the access device 12 determines if a counter is less than a predetermined threshold (FIG. 3, block 2024). If so, the access device 12 increments a counter, waits a predetermined amount of time, and attempts to restart the CaC agent (FIG. 3, blocks 2026, 2028, 2030). The process returns to block 2014. If after a predetermined number of times connectivity between the CaC agent 64 and the CaC controller 66 could not be established, the access device alters the configuration option 56 to cause the access device 12 to establish layer 3 connectivity with the service provider network 17 using the backup network service 38 during the initialization phase (FIG. 3, block 2032). The access device 12 then causes the access device 12 to reboot (FIG. 3, block 2034).

If at block 2014 connectivity between the CaC agent 64 and the CaC controller 66 was established, and subsequent to the blocks 2016-2022, the access device 12 continuously monitors the connectivity between the CaC agent 64 and the CaC controller 66. In one implementation, the access device 12 may periodically send to a computing device via the main network service 62, a message that requests a reply from the computing device. The access device 12 may set a timer. If no reply has been received by the access device 12 prior to the timer expiring, the access device 12 may determine that connectivity between the CaC agent 64 and the CaC controller 66 has been lost.

The access device 12 may then perform steps similar to blocks 2014, 2024, 2026, 2028 and 2030 in an attempt to determine whether restarting the CaC agent 64 may reestablish connectivity. If not, the access device 12 then performs blocks 2032 and 2034 and reboots. The access device 12 then begins the initialization phase again (FIG. 3, block 2000). The access device 12 accesses the configuration option 56 (FIG. 3, block 2002). The access device 12 determines, based on the configuration option 56, that the access device 12 is to enter the non-CaC mode (e.g., “ENABLE_MAIN=N”) (FIG. 3, block 2004). The access device 12 starts the backup network service 74 to establish layer 3 connectivity to the service provider network 17 (FIG. 3, block 2036). The access device 12 alters the telemetry configuration option in the configuration option 56 to use the backup telemetry plug-in 60 (FIG. 3, block 2038). The access device 12 initiates a connection monitor to determine if there is connectivity to the CaC controller 66 (FIG. 3, blocks 2040, 2042). If so, the access device 12 alters the configuration option 56 to cause the access device 12 to establish layer 3 connectivity with the service provider network 17 using the main network service 36 during the initialization phase (FIG. 3, block 2044). The access device 12 then causes the access device 12 to reboot (FIG. 3, block 2034).

If at block 2042 the access device determines that there is no connectivity to the CaC controller 66, the access device 12 initiates the telemetry collector 76 (FIG. 3, block 2016). The telemetry collector 76 accesses the telemetry configuration option and determines that the backup telemetry plug-in 60 is to be used to collect and stream the telemetry data rather than the main network service telemetry plug-in 58 (FIG. 3, block 2018). The telemetry collector 76 instantiates the backup telemetry plug-in 60 as executing backup telemetry process 78 (FIG. 3, block 2020). The access device 12 initiates the telemetry components 80-90. The telemetry collector 76 begins streaming the telemetry data via the backup network service 74 to the telemetry service 42 (FIG. 3, block 2022).

At step 2043 the access device 12 may continuously monitor connectivity to the CaC controller 66 to determine if connectivity to the CaC controller 66 becomes available. If at step 2043 the access device 12 determines that connectivity to the CaC controller 66 has been re-established, the access device 12 alters the configuration option 56 to cause the access device 12 to establish layer 3 connectivity with the service provider network 17 using the main network service 36 during the initialization phase (FIG. 3, block 2044). The access device 12 then causes the access device 12 to reboot (FIG. 3, block 2034). Otherwise, the telemetry collector 68 continues to stream the telemetry data via the CaC agent 64 to the telemetry service 42 (FIG. 3, block 2022).

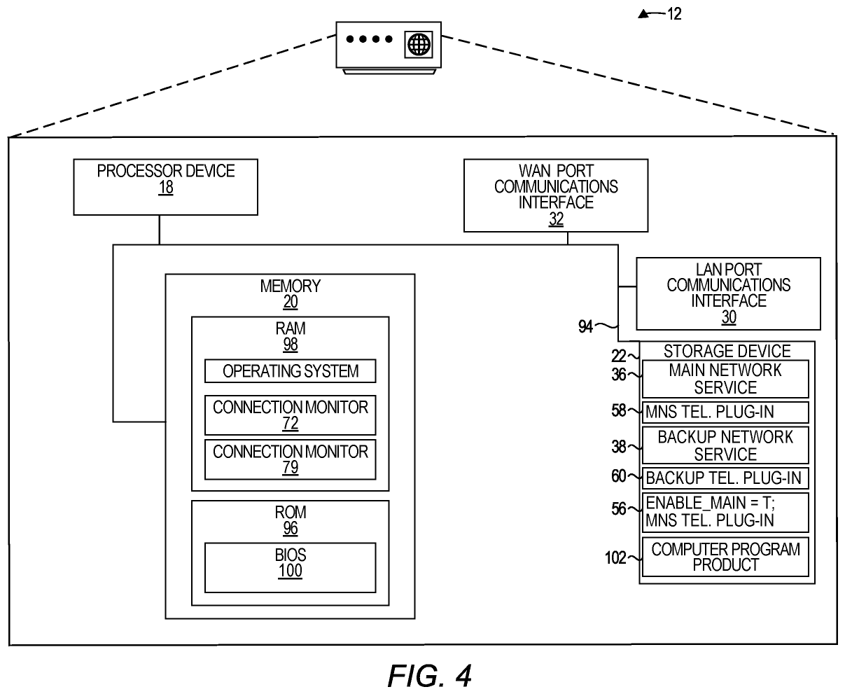

FIG. 4 is a block diagram of the access device 12 suitable for implementing examples according to one implementation. The access device 12 may comprise, for example, a cable modem or an optical network unit. The access device 12 includes the one or more processor devices 18, the system memory 20, and a system bus 94. The system bus 94 provides an interface for system components including, but not limited to, the system memory 20 and the processor device 18. The processor device 18 can be any commercially available or proprietary processor.

The system bus 94 may be any of several types of bus structures that may further interconnect to a memory bus (with or without a memory controller), a peripheral bus, and/or a local bus using any of a variety of commercially available bus architectures. The system memory 20 may include non-volatile memory 96 (e.g., read-only memory (ROM), erasable programmable read-only memory (EPROM), electrically erasable programmable read-only memory (EEPROM), etc.), and volatile memory 98 (e.g., random-access memory (RAM)). A basic input/output system (BIOS) 100 may be stored in the non-volatile memory 96 and can include the basic routines that help to transfer information between elements within the access device 12. The volatile memory 98 may also include a high-speed RAM, such as static RAM, for caching data.

The access device 12 may further include or be coupled to a non-transitory computer-readable storage medium such as the storage device 22, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 22 and other drives associated with computer-readable media and computer-usable media may provide non-volatile storage of data, data structures, computer-executable instructions, and the like.

A number of modules can be stored in the storage device 22 and in the volatile memory 98, including an operating system and one or more program modules, such as the connection monitor 72, which may implement the functionality described herein in whole or in part. All or a portion of the examples may be implemented as a computer program product 102 stored on a transitory or non-transitory computer-usable or computer-readable storage medium, such as the storage device 22, which includes complex programming instructions, such as complex computer-readable program code, to cause the processor device 18 to carry out the steps described herein. Thus, the computer-readable program code can comprise software instructions for implementing the functionality of the examples described herein when executed on the processor device 18.

The access device 12 may also include the LAN port communications interface 30 suitable for communicating with the LAN 14 and the WAN port communications interface 32 suitable for communicating with the aggregation device 16.

Individuals will recognize improvements and modifications to the preferred examples of the disclosure. All such improvements and modifications are considered within the scope of the concepts disclosed herein and the claims that follow.

What is claimed is:

1. A method, comprising:
establishing, by an access device communicatively coupled to a local area network (LAN) and to an aggregation device in a service provider network, layer 3 connectivity with the service provider network via a main network service;
subsequent to establishing layer 3 connectivity to the service provider network, determining, by the access device, that the main network service has lost layer 3 connectivity to the service provider network; and
attempting, by the access device, to re-establish layer 3 connectivity with the service provider network using a backup network service.

2. The method of claim 1, wherein establishing the layer 3 connectivity with the service provider network via the main network service further comprises establishing the layer 3 connectivity with the service provider network via the main network service during an initialization phase of the access device.

3. The method of claim 1, further comprising:
prior to attempting, by the access device, to re-establish layer 3 connectivity with the service provider network using the backup network service, altering, by the access device, a configuration option to cause the access device to establish layer 3 connectivity with the service provider network using the backup network service during an initialization phase; and
wherein attempting, by the access device, to re-establish layer 3 connectivity with the service provider network using the backup network service further comprises causing, by the access device, the access device to re-enter the initialization phase.

4. The method of claim 3, wherein causing, by the access device, the access device to re-enter the initialization phase comprises causing, by the access device, the access device to reboot.

5. The method of claim 1, wherein the access device is communicatively coupled to the LAN via a LAN port of the access device and is communicatively coupled to the service provider network via a WAN port of the access device.

6. The method of claim 1, wherein the access device comprises a cable modem or an optical network unit.

7. The method of claim 1, further comprising:
accessing, by the access device, telemetry data; and
prior to determining, by the access device, that the main network service has lost layer 3 connectivity to the service provider network, sending, by the access device, the telemetry data via the main network service.

8. The method of claim 7, wherein the telemetry data comprises one or more of: an upstream channel frequency used by the access device to send data to the aggregation device, a downstream channel frequency used by the access device to receive data from the aggregation device, round-trip latency times between the access device and one or more wireless computing devices communicatively coupled to the LAN and the access device, packet count information that identifies an aggregate quantity of packets transmitted by a computing device communicatively coupled to the LAN, and a DOCSIS latency that identifies a latency between the access device and the aggregation device.

9. The method of claim 1, wherein subsequently determining, by the access device, that the main network service has lost layer 3 connectivity to the service provider network further comprises accessing, by a command and control agent executing on the access device, configuration data that identifies whether connectivity to a command and control controller in the service provider network exists.

10. The method of claim 1, wherein attempting, by the access device, to re-establish layer 3 connectivity with the service provider network using the backup network service comprises:
entering, by the access device, an initialization phase of the access device;
accessing a configuration option;
determining, based on the configuration option, to establish layer 3 connectivity with the service provider network using the backup network service; and
initiating, by the access device, the backup network service to establish layer 3 connectivity with the service provider network.

11. The method of claim 1, wherein the aggregation device comprises a cable modem termination system or an optical line terminal.

12. The method of claim 1, further comprising:
in response to establishing layer 3 connectivity with the service provider network via the main network service, initiating, by the access device, a main network service telemetry process from a plurality of telemetry processes.

13. The method of claim 12, further comprising:
subsequent to establishing layer 3 connectivity with the service provider network via the backup network service, initiating, by the access device, a backup telemetry process in lieu of the main network service telemetry process.

14. The method of claim 13, further comprising:
subsequent to establishing layer 3 connectivity with the service provider network via the backup network service, continuously monitoring, by the access device, availability of a command and control controller in the service provider network;
determining, by the access device, that the command and control controller in the service provider network has become available; and
in response to determining, by the access device, that the command and control controller in the service provider network has become available, attempting to re-establish layer 3 connectivity with the service provider network using the main network service.

15. An access device, comprising:
a memory; and
one or more processor devices operable to:
establish layer 3 connectivity with a service provider network via a main network service;
subsequent to establishing layer 3 connectivity to the service provider network, determine that the main network service has lost layer 3 connectivity to the service provider network; and
attempt to re-establish layer 3 connectivity with the service provider network using a backup network service.

16. The access device of claim 15, wherein the access device comprises a cable modem or an optical network unit.

17. The access device of claim 15, wherein to attempt to re-establish layer 3 connectivity with the service provider network using the backup network service, the one or more processor devices are further operable to:
enter an initialization phase of the access device;
access a configuration option;
determine, based on the configuration option, to establish layer 3 connectivity with the service provider network using the backup network service; and
initiate the backup network service to establish layer 3 connectivity with the service provider network.

18. The access device of claim 15, wherein the one or more processor devices are further operable to:
in response to establishing layer 3 connectivity with the service provider network via the main network service, initiate a main network service telemetry process from a plurality of telemetry processes.

19. A non-transitory computer-readable storage medium that includes executable instructions operable to cause one or more processor devices of an access device to:
establish layer 3 connectivity with a service provider network via a main network service;
subsequent to establishing layer 3 connectivity to the service provider network, determine that the main network service has lost layer 3 connectivity to the service provider network; and
attempt to re-establish layer 3 connectivity with the service provider network using a backup network service.

20. The non-transitory computer-readable storage medium of claim 19, wherein to attempt to re-establish layer 3 connectivity with the service provider network using the backup network service, the executable instructions are further operable to cause the one or more processor devices to:
enter an initialization phase of the access device;
access a configuration option;
determine, based on the configuration option, to establish layer 3 connectivity with the service provider network using the backup network service; and
initiate the backup network service to establish layer 3 connectivity with the service provider network.

21. The non-transitory computer-readable storage medium of claim 19, wherein prior to attempting to re-establish layer 3 connectivity with the service provider network using the backup network service, the executable instructions are further operable to cause the one or more processor devices to alter a configuration option to cause the access device to establish layer 3 connectivity with the service provider network using the backup network service during an initialization phase; and
wherein to attempt to re-establish layer 3 connectivity with the service provider network using the backup network service, the executable instructions are further operable to cause the one or more processor devices to cause the access device to re-enter the initialization phase.
